(19) United States
(12) Patent Application Publication
(10) Pub. No.: US 2026/0346501 A1
(43) Pub. Date: Nov. 5, 2026

(54) TWO PIECE DENSIFIED SLURRY LAYER EXTRACTOR PORT FOR WALLBOARD MIXER

(71) Applicant: UNITED STATES GYPSUM COMPANY, Chicago, IL (US)

(72) Inventor: Nicholas Stephen JONES, Valparaiso, IN (US)

(21) Appl. No.: 19/534,011

(22) Filed: Feb. 9, 2026

Related U.S. Application Data
(60) Provisional application No. 63/799,142, filed on May 2, 2025.

(51) Int. Cl. B28C 7/16; B01F 35/511; B01F 35/75; B01F 101/28

(52) U.S. Cl. CPC B28C 7/16; B01F 35/511; B01F 35/7547; B01F 2101/28

(57) ABSTRACT

A two piece densified slurry layer extractor port for a wallboard mixer is provided, including an adapter housing with an open upper end defining a chamber, and an internal passageway in fluid communication with a tubular outlet port extending from an opposite lower end of the housing, a wear part dimensioned for releasable engagement in the chamber, having a “V”-shaped inlet port and a wear part passage in fluid communication with said internal passage; and the wear part having a body with at least one fastening location configured for accommodating a fastener passing through the adapter housing for preventing movement of the wear part in the chamber.

### RELATED APPLICATION

This application is a Non-Provisional of, and claims 35 U.S.C. 119 priority from, US Provisional Application Serial No. 63/799,142 filed May 2, 2025, the entire contents of which are incorporated by reference herein.

### BACKGROUND

The present disclosure generally relates to a method and apparatus for preparing gypsum products from starting materials including calcined gypsum and water, and more particularly relates to an improved slurry mixer used in supplying agitated gypsum slurry to a wallboard production line used for manufacturing wallboard having outer layers with higher densities.

It is well known to produce gypsum products by dispersing calcined gypsum in water to form a slurry, then casting the slurry into a desired shaped mold or onto a moving surface, and allowing the slurry to set to form hardened gypsum by reaction of the calcined gypsum (calcium sulfate hemihydrite or anhydrite) with the water to form hydrated gypsum (calcium sulfate dihydrate). In preferred embodiments, for producing gypsum wallboard with a densified slurry layer, the slurry is poured upon a layer of face paper moving along a conveyor line, and after the slurry is deposited and spread, a second layer of backing paper is oriented on an upper surface of the slurry. Subsequently, the paper layers and slurry are formed into a desired panel shape prior to the slurry setting or hardening.

It is common in conventional gypsum wallboard manufacturing to introduce foam into the slurry to reduce weight of the resulting densified slurry layer. Prior apparatus and methods for addressing some of the operational problems associated with the production of foamed gypsum are disclosed in commonly-assigned U.S. Pat. Nos. 5,638,635; 5,643,510; 6,494,609; and 6,874,930; all of which are incorporated by reference.

A gypsum wallboard mixer typically includes a housing defining a mixing chamber with inlets for receiving sources of calcined gypsum and water, among other additives well known in the art. The mixer includes an impeller or other type of agitator for agitating the contents to be mixed into a mixture or slurry. Vertically projecting lugs attached to the impeller are known as pins. Such mixers typically have a preferably rectangular discharge gate or slot with a cutoff block or door. A suitable depiction of such a prior art mixer is in US 10,011,045, the contents of which are incorporated by reference herein.

It is known in the art to produce wallboard having a densified slurry layer with multi-layer gypsum construction, including a first gypsum layer located adjacent a face paper and having a first density, and a second gypsum layer applied upon the first layer. The second layer has a second density which is usually lower than that of the first layer. The higher density of the first layer, achieved by the injection of less foam or water, has been found to bond more securely to the face paper. The above-described process for producing multi-layered, variable density wallboard is often referred to as wallboard having a densified slurry layer.

To efficiently deliver these two different density gypsum slurries, the mixer has a first extractor port configured for generating the higher density slurry for the first gypsum layer, and a second extractor port configured for generating the lower density slurry for the second gypsum layer. Typically, the first extractor port, also referred to as the densified slurry layer extractor port, is disposed on a mixer sidewall, and connected to a separate entrance for receiving the mixed slurry. Included on the conventional extractor port is an inlet located inside the mixer chamber, which receives the relatively higher density slurry, and emits the slurry through a port extending from an exterior mixer wall. A hose attached to the port to convey the slurry to a densified slurry layer roller on the wallboard production line.

It is well known to practitioners in this art, that gypsum wallboard slurry is very abrasive. To address this property, conventional densified slurry layer extractor ports are made of 304 Stainless Steel and are chrome plated to extend the working live of the port, and to prevent material adhering to the port surfaces. However, even with these precautions, the conventional densified slurry layer extractor ports are still prone to abrasion, in part due to the chrome plating wearing off during use. Once the chrome plating wears off, the densified slurry layer extractor port is prone to shortened life due to resulting lumps and plugs of prematurely set slurry particles. In many cases, the worn densified slurry layer extractor port must be removed. Due to the material and plating, each extractor port is expensive, costing as much as $1,000, not including the labor of replacement and the lost revenue due to mixer down time while the port is replaced. During normal operation, conventional densified slurry layer extractor ports last only about 1-2 months. Given that major manufacturers of gypsum wallboard operate multiple plants, each having at least one mixer, this extractor port corrosion problem becomes significant. Also, due to environmental and/or market factors, it is becoming more difficult to obtain chrome-plated parts.

Accordingly, there is a need for an improved densified slurry layer extractor port that addresses the above-listed design drawbacks of conventional ports.

### SUMMARY

The above-listed need is met or exceeded by the present two piece densified slurry layer extractor port for a wallboard mixer, which features a two-piece construction. A first piece is referred to as an adapter, and connects to an extractor block that is itself secured to an outer wall of the mixer. A tubular port on the adapter is configured for connection to a slurry delivery hose, as is the case with the conventional densified slurry layer extractor ports. A chamber is defined by the adapter housing, and is dimensioned for removably accommodating a generally cylindrical wear piece. The wear piece features an upper end configured for receiving the wallboard slurry, including a generally “V”-shaped inlet port in fluid connection with a passageway that is itself in fluid communication with the tubular port in the adapter. Exterior formations such as dimples or recesses on a wear part body are configured for accommodating retaining fasteners. Preferably, the retaining fasteners are set screws inserted from an exterior of the adapter housing that retain the wear piece in the chamber of the adapter housing. As such, the wear part is prevented from operational rotation, or from becoming dislodged from the adapter housing. Also, the adapter housing is provided with clamp-like fasteners that retain the adapter to the extractor block on the mixer.

A feature of the present densified slurry layer extractor is that the wear part is made of 304 Stainless Steel but does not have to be chrome plated. Upon significant abrasion of the wear part, the adapter is removed from the extractor block and the wear part is easily removed and replaced. Since the adapter is not subject to slurry-induced erosion, the adapter needs not be replaced nearly as often as the wear part.

Another feature of the present densified slurry layer extractor is that the adapter is provided with a supplemental port accessible from the adapter housing and in fluid communication with the tubular adapter port for the further addition of water or other additives to the higher density slurry as needed in particular applications.

More specifically, a two piece densified slurry layer extractor port for a wallboard mixer is provided, including an adapter housing with an open upper end defining a chamber, and an internal passageway in fluid communication with a tubular outlet port extending from an opposite lower end of the housing, and a wear part dimensioned for releasable engagement in the chamber, having a “V”-shaped inlet port and a wear part passage in fluid communication with said internal passage. The wear part has a body with at least one fastening location configured for accommodating a fastener passing through the adapter housing for preventing movement of the wear part in the chamber.

In an optional construction, the wallboard mixer has an extractor block securable to an outer wall of the mixer, and the adapter housing has at least one formation for accommodating clips on the extractor block for securing the extractor port to the extractor port block. In another optional construction, the at least one formation is a slot located adjacent the open upper end of the adapter housing. In a preferred alternate construction, the at least one formation is located at a 90° spacing on the adapter housing from the fastening locations, which are 180° apart on the wear part body.

In another optional construction, the adaptor housing is provided with a supplemental port accessible from the adapter housing and in fluid communication with the tubular adapter port for the further addition of water or other additives.

In still another optional construction the at least one fastening location is one of a dimple and a recess. Also, in one optional construction, the “V”-shape defines a 60° angle. Further, in one construction, the wear part body is cylindrical in shape, has a diameter of 2.250 inches (5.715cm) and a height of 2.32 inches (5.8928 cm). Preferably, the wear part consists of 304 Stainless Steel.

In another embodiment, a wear part is provided for use in a two piece densified slurry layer extractor port including an adapter housing with an open upper end defining a chamber, and an internal passageway in fluid communication with a tubular outlet port extending from an opposite lower end of the housing, the wear part including a wear part body dimensioned for releasable engagement in the chamber, having a “V”-shaped inlet port defining a 60° angle and a wear part passage in fluid communication with the internal passage, the wear part body has at least one fastening location configured for accommodating a fastener passing through the adapter housing for preventing movement of the wear part in the chamber; and the wear part consisting of 304 Stainless Steel, being cylindrical in shape, having a diameter of 2.250 inches (5.715cm) and a height of 2.32 inches (5.8928 cm).

In yet another embodiment, a mixer for generating gypsum wallboard slurry is provided, including a mixer housing with a peripheral wall defining a mixer interior, at least one extractor port block fastened to the peripheral wall, the block having an opening in fluid communication with the mixer interior, the block further including at least one extractor clip, a two piece densified slurry layer extractor port securable to the extractor block, in fluid communication with the opening, and further including: an adapter housing with an open upper end defining a chamber, and an internal passageway in fluid communication with a tubular outlet port extending from an opposite lower end of the housing, a wear part dimensioned for releasable engagement in the chamber, having a “V”-shaped inlet port and a wear part passage in fluid communication with the internal passage, the wear part having a body with at least one fastening location configured for accommodating a fastener passing through the adapter housing for preventing movement of the wear part in the chamber; and the adapter housing having has at least one formation for accommodating the extractor clips on the extractor block for securing the extractor port to the extractor port block.

### BRIEF DESCRIPTION OF THE DRAWINGS

FIG. 1 is a top perspective of a wallboard slurry mixer fitted with the present densified slurry layer extractor port;

FIG. 2 is a top perspective view of the present densified slurry layer extractor port assembly;

FIG. 3 is a to plan view of the structure of FIG. 2;

FIG. 4 is a front view of the structure of FIG. 2;

FIG. 5 is a vertical cross-section of the structure of FIG. 2;

FIG. 6 is a fragmentary vertical section of the assembly of FIG. 2;

FIG. 7 is a fragmentary top perspective view of the structure of FIG. 2;

FIG. 8 is a top perspective view of the densified slurry layer extractor port adapter;

FIG. 9 is a vertical cross-section of the adapter of FIG. 8;

FIG. 10 is a top view of the removable wear part of the present densified slurry layer extractor port assembly;

FIG. 11 is a top perspective view of the wear part of FIG. 10; and

FIG. 12 is a vertical cross-section of the wear part of FIG. 11.

### DETAILED DESCRIPTION

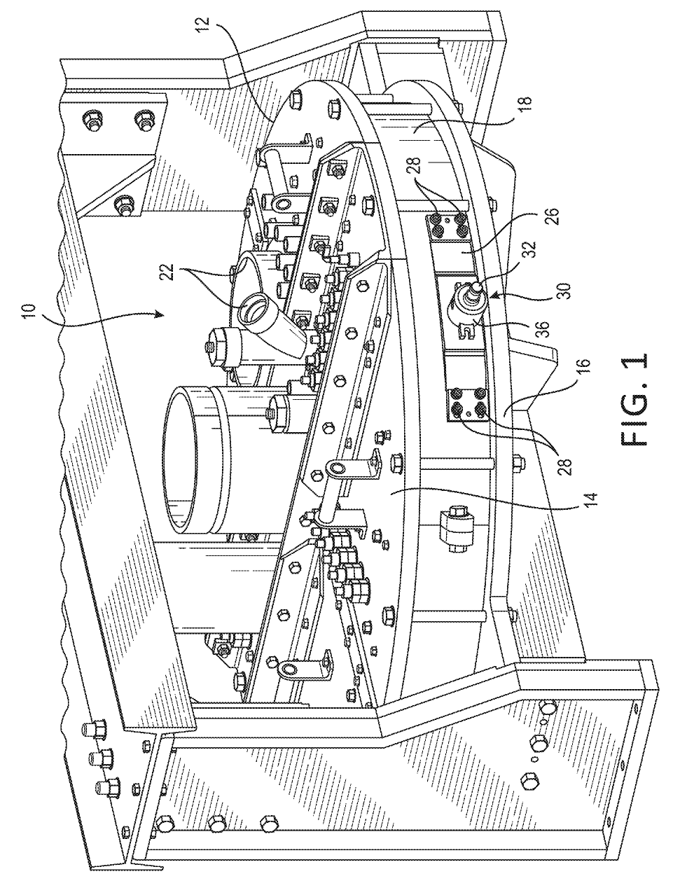

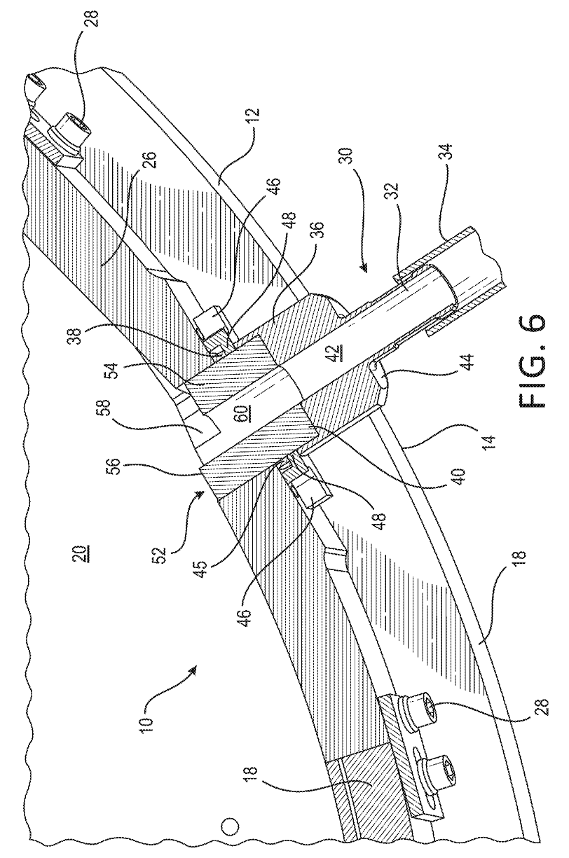

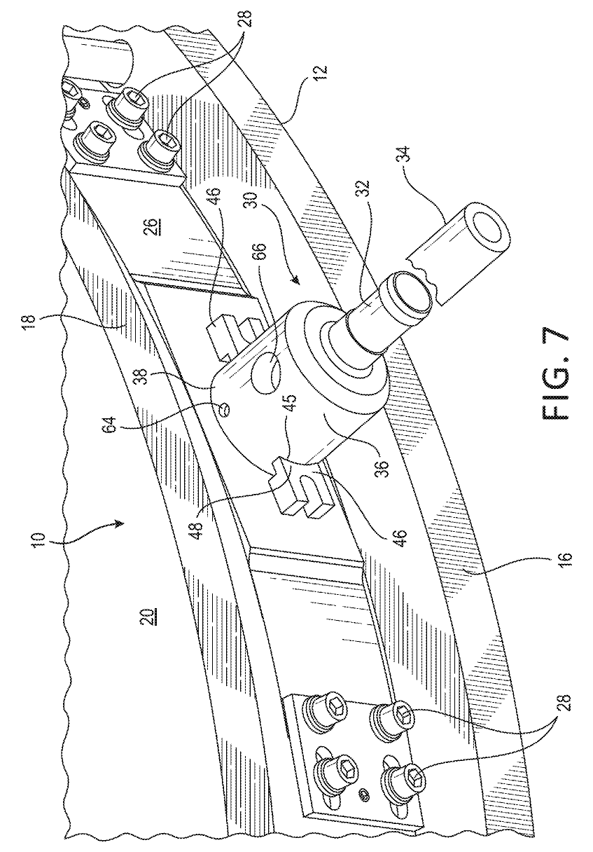

Referring now to FIG. 1, an exemplary mixer for mixing and dispensing a gypsum wallboard slurry is generally designated 10 and includes a mixer housing 12 configured for receiving and mixing the slurry. Included on the housing 12 is an upper plate 14, a lower plate 16 spaced apart by a peripheral wall 18. The housing 12 defines a mixing chamber 20 (FIGS. 6 and 7) enclosing a rotating mixing platform and/or agitators or impellers (not shown) for agitating calcined dry gypsum, water and other additives and ingredients well known in the art (e.g. accelerators, retarders, fillers, starch, binders, strengtheners, etc.) which are introduced via associated inlet ports 22. Gypsum wallboard slurry mixers are well known in the art and are described in greater detail in the patents referenced above.

Typically, an agitator (not shown) is disposed in the mixing chamber 20 operated by a conventional drive source, such as a motor, for rotating the agitator at whatever speed is appropriate for mixing the contents of the mixing chamber. Motor speeds in the range of 275-300 rpm are common. This rotation directs the resulting aqueous slurry in a generally centrifugal direction, such as in a counterclockwise outward spiral towards the peripheral wall 18. The direction of rotation is a function of the mixer design and/or construction, and may vary to suit the application.

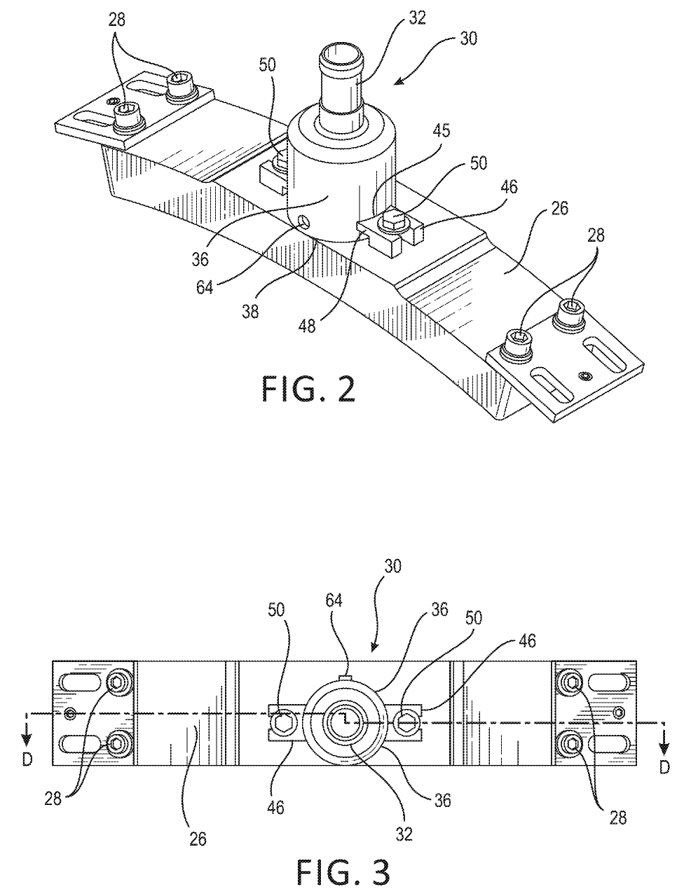

Referring now to FIGS. 1-6, an extractor block or extractor port block 26 is releasably mounted in an opening in the peripheral wall 18 using fasteners 28. The extractor port block 26 is separate from a main mixer discharge port (not shown), the latter used for the discharge of the major portion of the well-mixed slurry. As described above, it is preferred that the extractor port block 26 has a densified slurry layer extractor port 30 configured for emitting a first or higher density slurry for a first gypsum layer, and the main extractor port (not shown) is configured for generating a second or lower density slurry for a second gypsum layer. A multi-layer gypsum wallboard is made using the first and second gypsum layers.

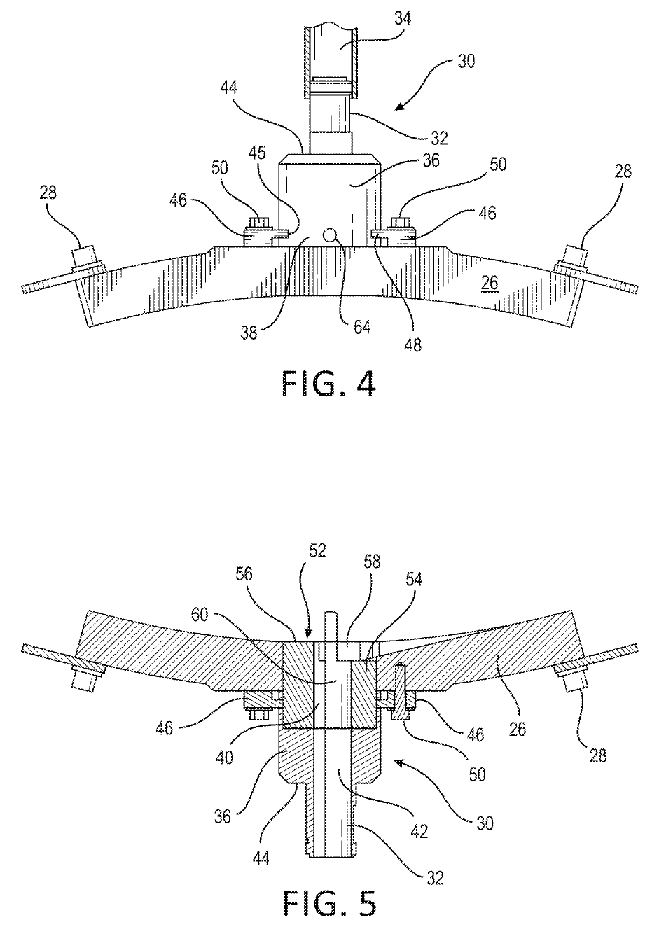

In operation, the densified slurry layer extractor port 30 receives the relatively higher density densified slurry layer slurry from the mixing chamber 20, and emits the slurry through a tubular outlet port 32 which is connected to a flexible delivery hose 34 (FIGS. 4, 6 and 7). To address the problem of extractor port erosion described above, the present extractor port 30 features a two piece construction that allows for a removable wear part that is easily replaced once eroded through use.

Referring now to FIGS. 5-7 and 9-12, the densified slurry layer extractor port 30 includes as a first part an adapter housing 36 with an open upper end 38 defining a chamber 40. An internal passageway 42 is in fluid communication with the tubular outlet port 32, the latter extending from an opposite lower end 44 of the housing. At least one formation 45 on the adapter housing 36 is configured for accommodating clips 46 on the extractor block 26 for securing the extractor port to the extractor port block. Preferably, the formations 45 are slot-shaped for receiving tabs 48 of the clips 46, and the formations are preferably located diametrically apart on the generally cylindrical adapter housing 36. The clips 46 are held in place on the extractor port block 26 using fasteners 50 such as screws or the like.

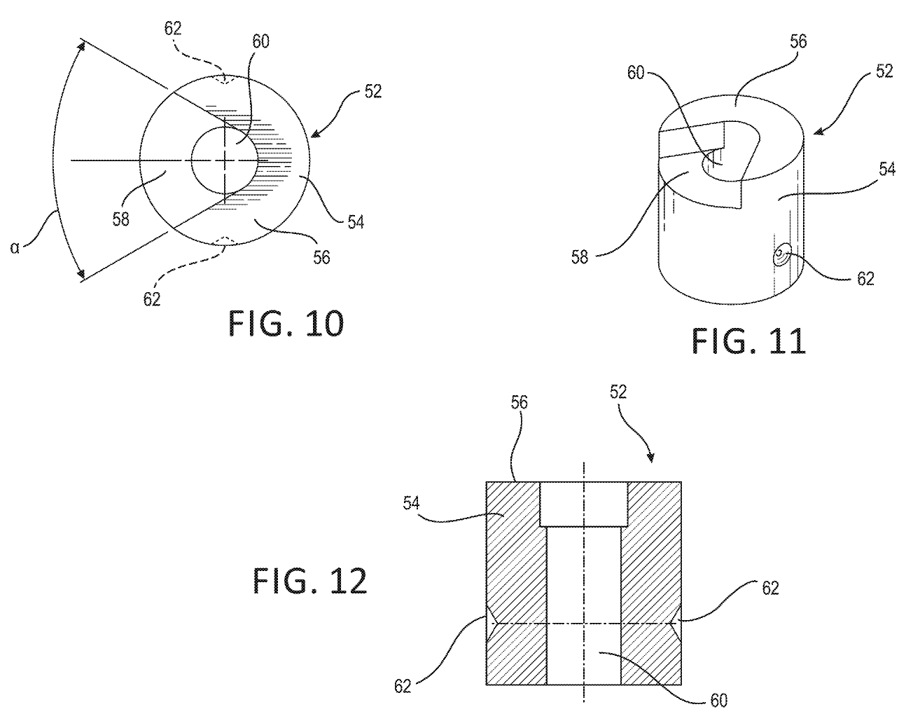

As a second part of the present densified slurry layer extractor port 30, a wear part 52 is dimensioned for releasable engagement in the chamber 40, having a generally cylindrical body 54, with an upper end 56 provided with a “V”-shaped inlet port 58 and a wear part passage 60 in fluid communication with the internal passageway 42. The wear part passage 60 is preferably axially located in the body 54, however other positions are contemplated depending on the application. The “V”-shaped inlet port 58 preferably defines an angle α of 60°(FIG. 10). However, the size of the angle α may vary to suit the application.

Since the wear part 52 is designed for easy removal and replacement from the adapter housing 36, another feature is the use of at least one fastening location 62 configured for accommodating a fastener passing through the adapter housing for preventing movement of the wear part in the chamber 40. In the preferred embodiment, the fastening location 62 is one of a dimple and a recess, however other shapes are contemplated depending on the application, and as long as a fastener inserted through a fastener opening 64 secures the wear part 52 against unwanted rotation or other movement within the chamber 40. It is also preferred that the fasteners used to secure the wear part 52 in the chamber 40 are set screws or the like. Another feature of the adapter housing 36 is that each formation 45 is preferably located at a 90° spacing on the adapter housing from the fastener openings 64, associated with the fastening locations 62, which are 180° apart on the wear part body 54.

Also, for proper fitting within the chamber 40, while dimensions are contemplated as varying to suit the application the wear part 52 has a preferred diameter of 2.250 inches (5.715cm) and a preferred height of 2.32 inches (5.8928 cm). In a preferred embodiment, the wear part 52 is made entirely of 304 Stainless Steel. Chrome plating is not needed.

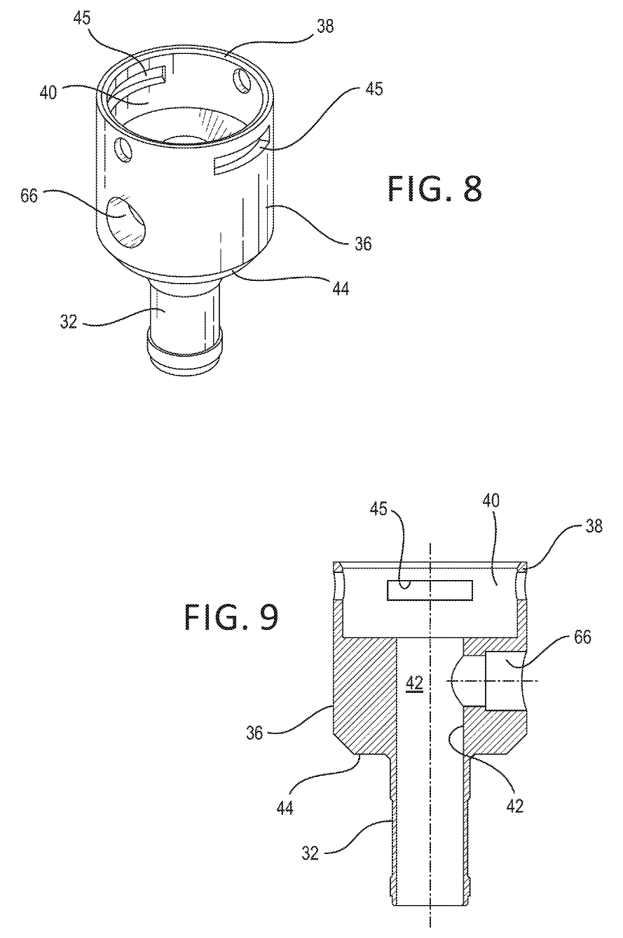

Referring now to FIGS. 7-9, another feature of the adapter housing 36 is a supplemental port 66 in fluid communication with the tubular adapter port 32 for the further addition of water or other additives to the densified slurry layer slurry. In a preferred embodiment, the supplemental port 66 extends at a 90° angle to the tubular outlet port 32.

While a particular embodiment of the present two piece densified slurry layer extractor port for a wallboard mixer has been described herein, it will be appreciated by those skilled in the art that changes and modifications may be made thereto without departing from the invention in its broader aspects and as set forth in the following claims.

1. A two piece densified slurry layer extractor port for a wallboard mixer, comprising:
an adapter housing with an open upper end defining a chamber, and an internal passageway in fluid communication with a tubular outlet port extending from an opposite lower end of said housing;
a wear part dimensioned for releasable engagement in said chamber, having a “V”-shaped inlet port and a wear part passage in fluid communication with said internal passage; and
said wear part having a body with at least one fastening location configured for accommodating a fastener passing through said adapter housing for preventing movement of said wear part in said chamber.

2. The two piece densified slurry layer extractor port of claim 1, wherein said wallboard mixer has an extractor block securable to an outer wall of the mixer, and said adapter housing has at least one formation for accommodating clips on the extractor block for securing said extractor port to the extractor port block.

3. The two piece densified slurry layer extractor port of claim 2, wherein said at least one formation is a slot located adjacent said open upper end of said adapter housing.

4. The two piece densified slurry layer extractor port of claim 2, wherein said at least one formation is located at a 90° spacing on said adapter housing from said fastening locations, which are 180° apart on said wear part body.

5. The two piece densified slurry layer extractor port of claim 1, wherein said adaptor housing is provided with a supplemental port accessible from the adapter housing and in fluid communication with the tubular adapter port for the further addition of water or other additives.

6. The two piece densified slurry layer extractor port of claim 1, wherein said at least one fastening location is one of a dimple and a recess.

7. The two piece densified slurry layer extractor port of claim 1, wherein said “V”-shape defines a 60° angle.

8. The two piece densified slurry layer extractor port of claim 1, wherein said wear part is cylindrical in shape, has a diameter of 2.250 inches (5.715cm) and a height of 2.32 inches (5.8928 cm).

9. The two piece densified slurry layer extractor port of claim 1, wherein said wear part consists of 304 Stainless Steel.

10. A wear part for use in a two piece densified slurry layer extractor port including an adapter housing with an open upper end defining a chamber, and an internal passageway in fluid communication with a tubular outlet port extending from an opposite lower end of said housing, said wear part comprising:
a wear part body dimensioned for releasable engagement in the chamber, having a “V”-shaped inlet port defining a 60° angle and a wear part passage in fluid communication with the internal passage;
said wear part having a body with at least one fastening location configured for accommodating a fastener passing through the adapter housing for preventing movement of said wear part in the chamber; and
said wear part consisting of 304 Stainless steel, being cylindrical in shape, having a diameter of 2.250 inches (5.715cm) and a height of 2.32 inches (5.8928 cm).

11. A mixer for generating gypsum wallboard slurry, said mixer comprising:
a mixer housing with a peripheral wall defining a mixer interior;
at least one extractor port block fastened to said peripheral wall, said block having an opening in fluid communication with said mixer interior, said block further including at least one extractor clip;
a two piece densified slurry layer extractor port securable to said extractor block, in fluid communication with said opening, and further including:
an adapter housing with an open upper end defining a chamber, and an internal passageway in fluid communication with a tubular outlet port extending from an opposite lower end of said housing;
a wear part dimensioned for releasable engagement in said chamber, having a “V”-shaped inlet port and a wear part passage in fluid communication with said internal passage;
said wear part having a body with at least one fastening location configured for accommodating a fastener passing through said adapter housing for preventing movement of said wear part in said chamber; and
said adapter housing having has at least one formation for accommodating said extractor clips on the extractor block for securing said extractor port to the extractor port block.
